(19) United States
(12) Patent Application Publication
(10) Pub. No.: US 2017/0369103 A1
(43) Pub. Date: Dec. 28, 2017

(54) MOTOR VEHICLE REAR PARCEL SHELF INCLUDING COMPOSITE MATERIAL

(71) Applicant: Issam KHAYAT, Lyon (FR)

(72) Inventor: Issam KHAYAT, Lyon (FR)

(73) Assignee: Compagnie Plastic Omnium, Lyon (FR)

(21) Appl. No.: 15/537,019

(22) PCT Filed: Dec. 10, 2015
(86) PCT No.: PCT/FR2015/053402

§ 371 Date: Jun. 16, 2017

(30) Foreign Application Priority Data
Dec. 19, 2014 (FR) 1462977

(51) Int. Cl. B62D 25/08; B60R 7/02; B60R 13/02; B60R 5/04; B60R 11/00

(52) U.S. Cl. CPC B62D 25/087; B60R 13/0268; B60R 5/044; B60R 7/02; B60R 2011/0024

(57) ABSTRACT

A motor vehicle rear parcel shelf configured to separate the passenger compartment from the luggage compartment of the vehicle, the motor vehicle rear parcel shelf including a first beam and a second beam, the first and second beams including composite material and configured to be rigidly connected to the two sides of the body of a motor vehicle, and a panel connecting the two beams together.

### FIELD OF THE INVENTION

This invention relates to a motor vehicle rear parcel shelf intended to separate the passenger compartment from the luggage compartment of the vehicle.

### BACKGROUND OF THE INVENTION

In all saloon-type vehicles having a boot at the rear of the vehicle, a part called the rear parcel shelf provides horizontal separation of the so-called passenger compartment area from that of the boot. This part is composed of a structure and a passenger compartment trim to obtain the inner appearance finish. The two latter elements must act as interfaces with numerous functions.

The structure of the rear parcel shelf is a structural component fully integrated in the body in white. The body in white is generally composed of sheet metal parts produced by stamping, these parts being assembled on the assembly line.

The structure of the rear parcel shelf plays a role in the overall stiffness of the vehicle, since it allows the complete structure of the vehicle to respond properly to the static and dynamic torsional stresses caused by the driving conditions. The rear parcel shelf stiffens the body in white in the median section (in the vertical direction), like the floor in the lower section, and the roof in the upper section.

This rear parcel shelf structure is therefore composed of stamped sheet metal parts, assembled onto the body in white before the painting phase, by various methods: welding, riveting and/or bonding.

The main drawback with this type of sheet metal structure is high weight, at a time when all car manufacturers are trying to minimize vehicle weight.

Moreover, the structure of the rear parcel shelf generally comprises a large number of parts, thus requiring numerous assembly operations to form an assembly ready to be assembled to a motor vehicle body in white.

Lastly, the structure of the rear parcel shelf comprises functional interfaces (10) with neighboring parts: passenger compartment and boot trim, seat belt attachment points, “isofix” attachment points (ISO standard for attachment points for child safety seats), subwoofer, wiring harnesses, etc. Each functional interface is generally integrated separately during assembly.

Thus, a rear parcel shelf structure requires, once assembled to the body in white, a large number of operations to mount the functional equipment onto the functional interfaces (10).

### OBJECT AND SUMMARY OF THE INVENTION

The invention aims to overcome these disadvantages by providing a light motor vehicle rear parcel shelf requiring no operations for assembling parts and functional interfaces (10), while guaranteeing its structural property.

Thus, the invention relates to a motor vehicle rear parcel shelf intended to separate the passenger compartment from the luggage compartment of the vehicle. The parcel shelf comprises:
a first beam and a second beam, said beams being made of composite material and designed to be connected rigidly to the two sides of the body of a motor vehicle; and
a panel made of composite material connecting the two beams together.

According to the invention, at least one of the beams may comprise a set of stiffening ribs, and at least one of the beams may comprise a hollow body to improve the rigidity.

Preferably, at least one of the beams comprises a set of molded functional interfaces and/or the panel comprises a set of molded functional interfaces.

According to the invention, at least one composite material may be selected from the following materials:
thermosetting material having reinforcing elements;
thermoplastic material having reinforcing elements.

Preferably, at least one end of at least one of the beams and/or the panel comprises a metal interface which can be used for connection with the sides of the body.

This metal interface can be attached to the beam and/or the panel by being overmolded, upset, bonded, inserted, riveted, screwed and/or crimped.

Advantageously, at least one of the beams comprises an assembly means at the two sides of the body, the means being obtained by the molding operation of said beam.

According to one embodiment, the first beam includes at least one of the following elements: a central Isofix attachment, a housing and an attachment for a central winder, attachment hooks and complements for a rear seat back.

According to one embodiment, the second beam includes a transverse support for rear window bonding track. The transverse support may be an overmolded metal insert.

According to one embodiment, the second beam includes at least one of the following elements: a central upper channel for evacuating rainwater around the boot opening, a central upper edge for insertion of a seal, a housing with a means for clipping a boot light.

According to one embodiment, the panel includes at least one of the following elements: the subwoofer enclosure, the amplifier mounting brackets, a network of ribs to clip wiring harnesses around the perimeter.

Advantageously, the parcel shelf may comprise a clip for passenger compartment trim providing the inner appearance finish.

Lastly, the panel may be attached to the first beam and/or the second beam.

The invention also relates to an assembly comprising a rear parcel shelf according to the invention and a motor vehicle body in white.

Preferably, the first beam can be connected to the sides of the body at the rear wheel arches, and the second beam can be connected to the sides of the body at an area that can support a vehicle rear window.

The parcel shelf can be connected to the sides of the body by a non-removable rigid mechanical connection at the ends of at least one beam.

### BRIEF DESCRIPTION OF THE DRAWINGS

The invention will be better understood on reading the accompanying figures, which are given solely by way of example and not limiting in any way, in which:

FIG. 1 illustrates an assembly of a rear parcel shelf according to the invention and a motor vehicle body in white.

FIGS. 2A to 2E illustrate various embodiments of the parcel shelf according to the invention.

FIG. 3 illustrates one of the beams of the rear parcel shelf according to the invention, provided with a rear window support.

FIG. 4 illustrates a set of ribs and a housing for a boot light.

FIG. 5 illustrates an embodiment of a means for assembling the parcel shelf to the sides of the body.

### MORE DETAILED DESCRIPTION

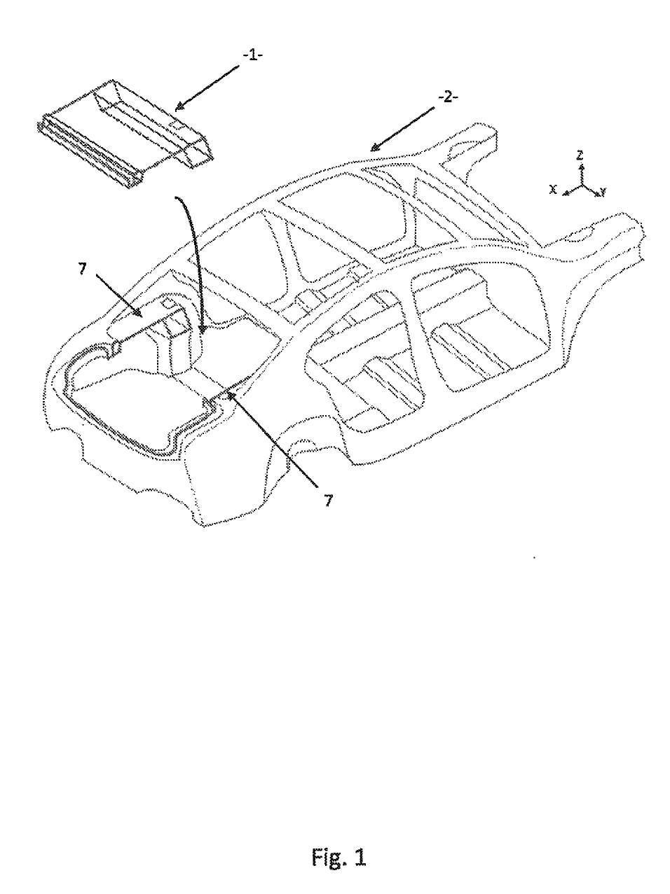

We now refer to FIG. 1 which illustrates a motor vehicle body in white (2) and a motor vehicle rear parcel shelf (1) according to the invention intended to separate the passenger compartment from the luggage compartment of the vehicle.

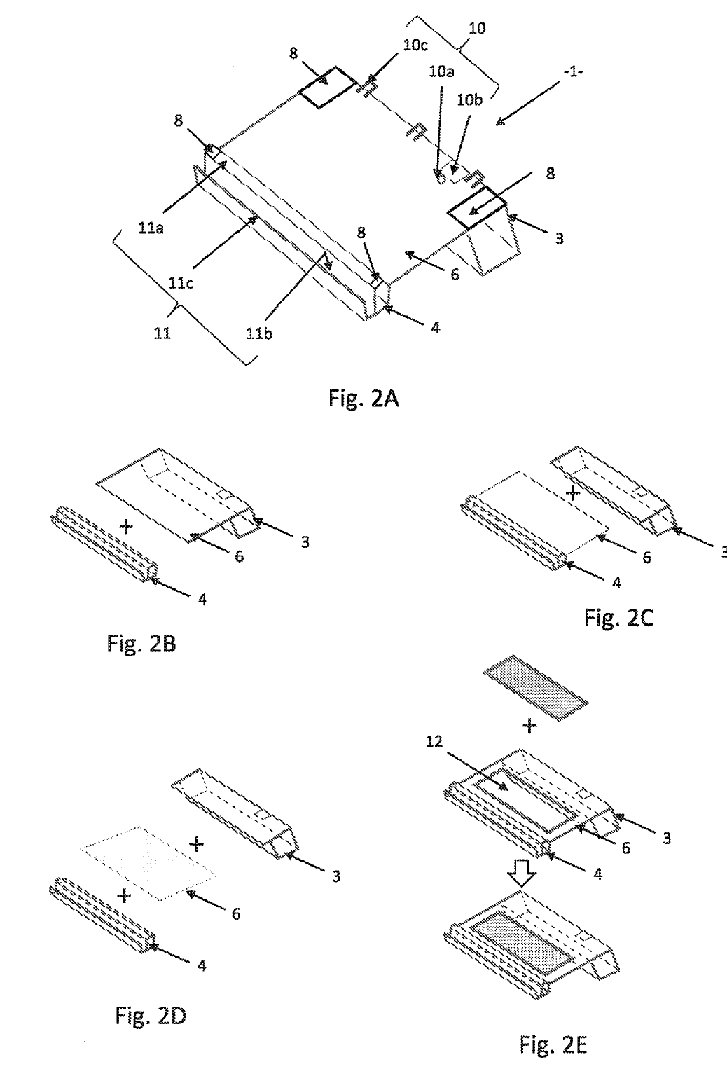

As shown in more detail on FIGS. 2A to 2E, the rear parcel shelf (1) comprises the following elements:
a first beam (3) consisting of at least one skin made of composite material designed to be connected rigidly to the two sides (7) of the body (side walls) of the vehicle, and which may comprise a first set of functional interfaces (10) molded with the first beam (3);
a second beam (4) consisting of at least one skin made of composite material designed to be connected rigidly to the two sides (7) of the body of the vehicle, and which may comprise a second set of functional interfaces (11) molded with the second beam (4), at least one of the beams (3, 4) comprising a set of stiffening ribs (5); and
a panel (6) made of composite material connecting the two beams (3, 4) together, said panel (6) comprising a third set of molded functional interfaces (12).

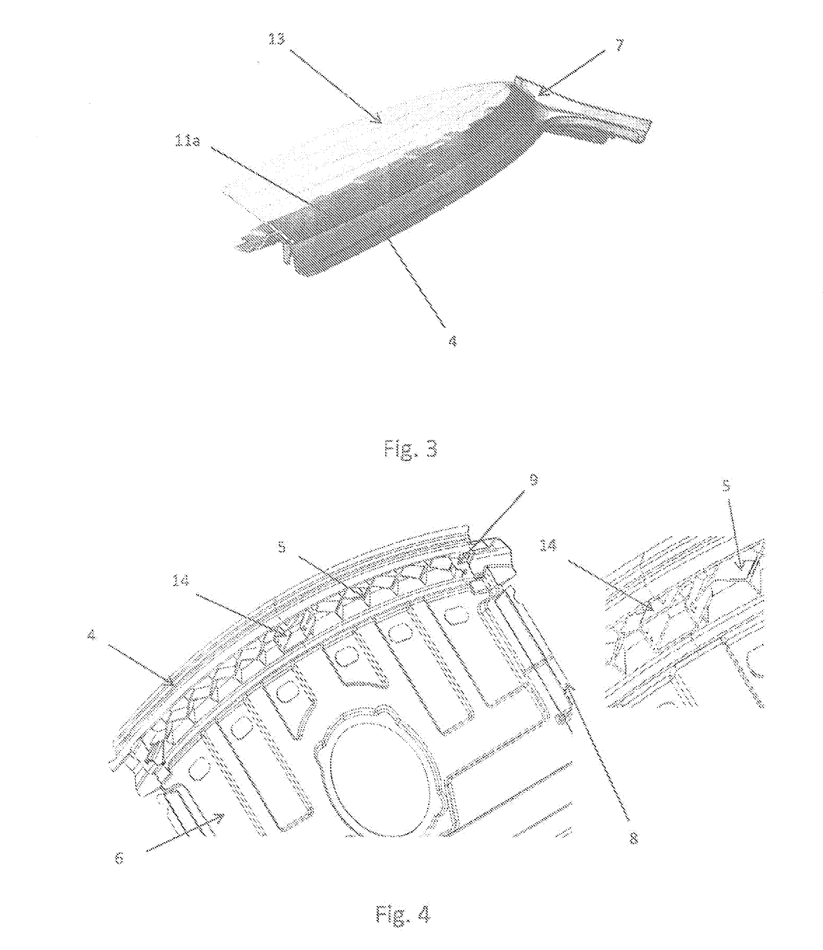

A skin means a continuous layer of composite material. Thus, according to the invention, at least one of the beams (3, 4) is preferably mono-skin with a set of ribs (5) to improve the rigidity (FIGS. 3, 4 and 5).

According to another embodiment, at least one of the beams (3, 4) comprises a hollow body to improve the rigidity (FIGS. 1 and 2A to 2E).

The two beams (3, 4) and the parcel shelf (1) may be composed of various composite materials. This or these composite materials can be selected from the following materials:
thermosetting materials having reinforcing elements. For example, SMC or epoxy thermosetting materials, comprising glass fibers, carbon fibers or a mixture of the two. These reinforcing elements may be cut fibers or reinforcements with unidirectional or woven continuous fibers;
thermoplastic materials comprising reinforcing elements. For example, thermoplastic materials resistant to the passage in the cataphoresis ovens or not resistant if the parcel shelf (1) is assembled after passing the body in white through the cataphoresis ovens. Amongst the thermoplastic materials, polyamides or polyolefins can be used. These thermoplastic materials comprise reinforcing elements such as glass fibers, carbon fibers or a mixture of the two. These reinforcing elements may be cut fibers or reinforcements with unidirectional or woven continuous fibers.

Since it is composed entirely of composite material, the rear parcel shelf (1) according to the invention offers significant weight savings compared with a parcel shelf of the prior art.

Preferably, a high-performance composite material is used, in other words a material comprising at least 50% by weight of reinforcing elements (glass fiber and/or carbon fiber, fabrics, UD, etc.), to further improve the rigidity of the rear parcel shelf (1).

The parcel shelf (1) acts structurally on the vehicle since it allows the complete structure of the vehicle to respond properly to the static and dynamic torsional stresses exerted on the suspensions and caused by the driving conditions.

The two beams (3, 4) are designed to be connected rigidly to the two sides (7) of the body of the vehicle, by a non-removable rigid assembly at the ends of the beams.

To do this, at least one end of at least one of the beams (3, 4) or of the panel (6), and preferably each end, may comprise a metal interface (8) (FIG. 2A for the beams and FIG. 4 for the panel) between the beam and the side of the body. This metal interface (8) acts as a rigid connection with the sides (7) of the body. It allows the use of rigid connections such as welding, to further improve the rigidity of the rear shelf (1).

This metal interface (8) can be attached to the beam (3, 4) by being overmolded, upset, bonded, inserted, riveted, screwed and/or crimped.

Still to allow the beams (3, 4) to be connected rigidly to the two sides (7) of the body of the vehicle, at least one of the beams (3, 4) may comprise an assembly means (9) at the two sides (7) of the body, the means (9) being obtained by molding the beam. Using a connection means obtained by molding limits the number of parts of the rear parcel shelf (1), and therefore limits the number of mounting and assembly operations.

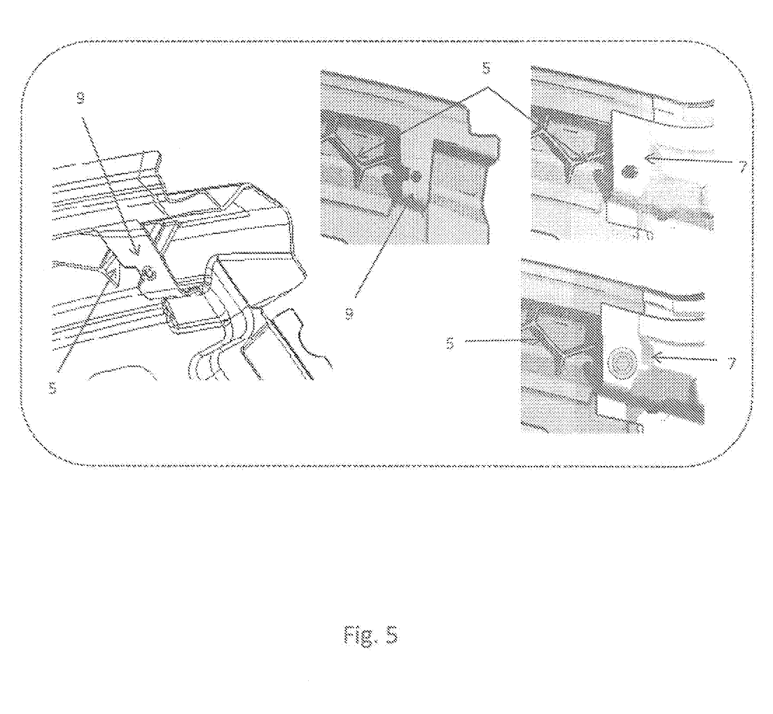

As illustrated on FIG. 5, brackets (9) can be used for example, obtained directly in the molding operation by moving a mobile core. Assembly with the side of the body can then be carried out using a nut and a screw inserted in the brackets (9).

The rear parcel shelf (1) comprises a set of functional interfaces (10, 11, 12) molded during the manufacture of said panel (6) and/or of said beams (3, 4).

This limits the number of parts of the rear parcel shelf (1), and therefore the number of mounting and assembly operations.

Thus, according to one embodiment, illustrated in detail on FIG. 3, the second beam (4) comprises a transverse support (11a) for a bonding track of a rear window (13) (window at the rear of the vehicle). This support (11a) avoids the need for an expensive operation which consists in preparing the surface of the beam for bonding by locally depositing a primer, this last operation possibly being difficult to automate.

Preferably, this support (11a) is a metal insert overmolded when molding the beam (4), at the bonding track of the rear window (13), so as to provide continuity of materials between the sides (7) of the body and the beam (4). A single type of adhesive, perfectly adapted to the materials over the entire length of the bonding track, can therefore be used.

The second beam (4) may also comprise the central upper channel (11b) for evacuating rainwater around the boot opening, and a central upper edge (11c) for insertion of a seal. In the section comprising the set of ribs (5), the second beam (4) may comprise a housing (14) for the boot light, illustrated on FIG. 4. This housing (14) is obtained by molding and preferably comprises openings on the walls in order to clip the light. This housing (14) also comprises a space to feed the lighting power supply and control harness and connect it.

The first beam (3) may include at least one of the following elements: a central Isofix attachment (10a), the housing and attachment (10b) for the central winder, the attachment hooks and complements (10c) for the rear seat back and isofix.

Lastly, the connection panel (6) may comprise the subwoofer enclosure (11a), the amplifier mounting brackets (11b) and/or a network of ribs (11c) to clip wiring harnesses intended to pass through the parcel shelf (1) to power the rear area of the vehicle.

Furthermore, the rear parcel shelf (1) may comprise a clip to attach a passenger compartment trim providing the inner appearance finish. This clip may be located on the periphery of the panel (6) at the interface of the trim contour, or in the center, and it may comprise one or two clipping points.

The panel (6) is attached to the first beam (3) and/or to the second beam (4) as illustrated on FIGS. 2A to 2D, for example by molding or overmolding.

The invention also relates to an assembly of a rear parcel shelf (1) according to the invention and of a motor vehicle body in white (2).

The parcel shelf (1) is connected to the sides (7) of the body in white (2) by a non-removable rigid mechanical connection at the ends of at least one beam (3, 4). The parcel shelf (1) can therefore be bonded, inserted, riveted, screwed and/or crimped to the sides (7) of the body.

The first beam (3) is preferably connected to the sides (7) of the body at the rear wheel arches.

The second beam (4) is preferably connected to the sides (7) of the body at an area capable of supporting a vehicle rear window.

It can be connected to the body components by a nut and a screw inserted in the brackets (9).

1. A motor vehicle rear parcel shelf configured to separate a passenger compartment from a luggage compartment thereof, the motor vehicle rear parcel shelf comprising:
a first beam and a second beam, said first and second beams including composite material and being connected rigidly to two sides of a body of the motor vehicle; and
a panel including composite material, the panel connecting the first and second beams together.

2. The motor vehicle rear parcel shelf according to claim 1, wherein at least one of the first and second beams comprises a set of stiffening ribs.

3. The motor vehicle rear parcel shelf according to claim 1, wherein at least one of the first and second beams comprises a hollow body to improve the rigidity.

4. The motor vehicle rear parcel shelf according to claim 1, wherein at least one of the first and second beams comprises a set of molded functional interfaces and/or the panel comprises a set of molded functional interfaces.

5. The motor vehicle rear parcel shelf according to claim 1, wherein at least one composite material is selected from:
a thermosetting material having reinforcing elements; and
a thermoplastic material having reinforcing elements.

6. The motor vehicle rear parcel shelf according to claim 1, wherein at least one end of at least one of the first and second beams and/or the panel comprises a metal interface configured to connect with the two sides of the body.

7. The motor vehicle rear parcel shelf according to claim 6, wherein the metal interface is attached to the beam and/or to the panel via at least one of overmolding, upsetting, bonding, inserting, riveting, screwing and crimping.

8. The motor vehicle rear parcel shelf according to claim 1, wherein at least one of the first and second beams comprises an assembly means at the two sides of the body, the assembly means being a result of molding at least one of the first and second beams.

9. The motor vehicle rear parcel shelf according to claim 1, wherein the first beam includes at least one of: a central Isofix attachment, a housing and an attachment for a central winder, attachment hooks and complements for a rear seat back.

10. The motor vehicle rear parcel shelf according to claim 1, wherein the second beam includes a transverse support for rear window bonding track.

11. The motor vehicle rear parcel shelf according to claim 10, wherein the transverse support is an overmolded metal insert.

12. The motor vehicle rear parcel shelf according to claim 1, wherein the second beam includes at least one of: a central upper channel configured to evacuate rainwater around the boot opening, a central upper edge configured to insert a seal, and a housing with a means for clipping a boot light.

13. The motor vehicle rear shelf according to claim 1, wherein the panel includes at least one of: a subwoofer enclosure, an amplifier mounting brackets, and a network of ribs configured to clip wiring harnesses around the perimeter.

14. The motor vehicle rear shelf according to claim 1, comprising a clip for passenger compartment trim configured to provide an inner appearance finish.

15. The motor vehicle rear shelf according to claim 1, wherein the panel is attached to the first beam and/or to the second beam.

16. An assembly of a rear parcel shelf according to claim 1, the assembly further comprising a motor vehicle body.

17. The assembly according to claim 16, wherein the first beam is connected to the two sides of the body at rear wheel arches.

18. The assembly according to claim 16, wherein the second beam is connected to the two sides of the body at an area configured to support a vehicle rear window.

19. The assembly according to claim 15, wherein the parcel shelf is connected to the two sides of the body by a non-removable rigid mechanical connection at ends of at least one beam.
